(19) United States
(12) Patent Application Publication
(10) Pub. No.: US 2015/0164119 A1
(43) Pub. Date: Jun. 18, 2015

(54) RED COMPOSITION

(71) Applicant: NESTEC S.A., Vevey (CH)

(72) Inventors: Souhila Ghidouche, Birmingham (GB); Christopher James Pipe, Lausanne (CH); Nicola Galaffu, Ornex (FR)

(21) Appl. No.: 14/413,352

(22) PCT Filed: Jul. 15, 2013
(86) PCT No.: PCT/EP2013/064876

§ 371 Date: Jan. 7, 2015

(30) Foreign Application Priority Data
Jul. 17, 2012 (EP) 12176717.2

(51) Int. Cl. A23L 1/275

(52) U.S. Cl. CPC A23L 1/2751; A23V 2002/00

(57) ABSTRACT

The present invention relates generally to the field of coloured compositions. One aspect of the invention is a red composition comprising quince juice wherein the quince juice imparts the red colour to the composition and wherein no sugar or acid is added. The invention provides for the use of a red composition comprising quince juice to colour a food product, a nutritional formulation, a food supplement, a beverage, an ink or a pharmaceutical product. A further aspect of the invention is a method of preparing a red composition comprising quince juice.

The present invention relates generally to the field of coloured compositions. One aspect of the invention is a red composition comprising quince juice wherein the quince juice imparts the red colour to the composition and wherein no sugars or acids are added. The invention provides for the use of a red composition comprising quince juice to colour a food product, a nutritional formulation, a food supplement, a beverage, an ink or a pharmaceutical product. A further aspect of the invention is a method of preparing a red composition comprising quince juice.

Colour is an important part of our everyday lives, influencing our moods and emotions and enhancing the enjoyment of our surroundings. Natural colours are all around us, for example in trees, leaves, vegetables and flowers. People have made use of colours since prehistoric times, and today colours are found in a wide variety of products including textiles, paints, printed materials, cosmetics and plastics. Colour is a particularly important aspect of our enjoyment of food and can even affect our perception of flavour and aroma (Christensen, C. M., (1983), Journal of Food Science, 48, 787-790 (1983)).

There is considerable interest in identifying colourants from natural sources as these have a greater consumer acceptance than synthetic colourants, especially when used in food or in other products which are to be ingested. The range of colours achievable with colourants from natural sources is currently not as extensive as can be achieved with synthetic colourants and in many cases the colourants from natural sources have lower stability when exposed to light, temperature or different acidities.

Red is one the most commonly used colours in foods. Currently, there are only a few red colours obtained from natural sources. These include anthocyanins, extracted from a range of plants including grape skin, black carrot and red cabbage; beetroot red, the principal colourant in which is betanin; lycopene, typically extracted from tomatoes; paprika, extracted from sweet red pepper; and carmine, the aluminium lake of cochineal extract, which is derived from the dried body of the female cochineal beetle. However, these red colours have a number of drawbacks. Some, such as paprika, have a strong taste and smell. Others, such as beetroot red and lycopene, show poor stability to light, heat or oxygen. Anthocyanins also generally have poor stability to light and heat, although this varies according to type of anthocyanin. The stability may be improved by interaction with metal ions or organic molecules. GB2119811 describes a red anthocyanin grape extract colourant stabilized with tannic acid. Anthocyanins are sensitive to pH, typically being red only in acidic conditions and becoming blue as the pH is increased. Carmine provides greater stability and lower use levels than most other naturally sourced colours, but its insect origin means that it is not suitable for vegetarians and is forbidden under major religious dietary laws. It would therefore be desirable to find new red coloured materials from natural sources which have good stability.

The flesh of quince fruit which is generally a pale yellow colour in its unprocessed state is known to turn red when cooked with sugar and acid, for example when making quince jam. In the absence of acid there is almost no colour change (Though small it is tasty>>Blog Archive>>Quince science [online] 13 Jun. 2011 [retrieved on 8 Jun. 2012]<URL: www.woolfit.com/wordpress/2011/06/13/quince-science/>). Cooking with acid is believed to turn the quince's colourless proanthocyanins to red anthocyanins. However, to date it has not been possible to exploit quince as a significant source of natural colourant.

Quince flesh has a strong flavour, is astringent and is high in pectin. This greatly limits the use of red coloured quince flesh to colour other materials such as foods. After cooking quince with acid and sugar, the cooking liquor, together with juice extracted from the cooked fruit, can provide small amounts of red colour, but the majority of the red colour remains in the flesh.

Quince jelly can be made by boiling quince flesh in water for a few hours, breaking up the flesh and then straining the mixture to obtain the almost colourless cooking liquid. The cooking liquid is then mixed with pectin, lemon juice and sugar and boiled once more, during which time it turns red. Once cooled, the liquid sets to form a red coloured jelly (Celia @ Fig Jam and Lime Cordial, Quince Jelly [online] 26 Oct. 2010 [retrieved on 11 Jun. 2012]<http://figjamandlimecordial.com/2010/10/26/quince-jelly/>). Even without the addition of pectin this red liquid is viscous and cannot readily be spray-dried. Spray drying is a convenient method for producing a powder form of coloured compositions for use in colouring other materials and so the high viscosity of the liquid limits its potential uses. The presence of lemon juice in this process makes the liquid very acidic which also limits its desirability as a red colour. For example in foods such as yoghurts, ingredients with a low pH can adversely affect the taste. The acidity can be neutralized by the addition of alkalis, but often this is not appropriate in the production of a natural colour, particularly for food use where consumers would prefer to just see the pure fruit on the ingredient list without additives such as acids and alkalis.

Hamauzu found that phenolic extracts from the Chinese quince (Pseudocydonia sinensis) became red when heated for 12 hours with citric acid at 95° C. (Y. Hamauzu et al., Journal of Agricultural and Food Chemistry, 55, 1221-1226 (2007)). However, the process of extraction from the quince flesh involved freeze-drying, petroleum ether washing, extraction into acetone and purification on a column washed a solution of 0.1% trifluoroacetic acid. Such extraction techniques are not suitable for the production of natural coloured materials for many applications, especially food.

It would therefore be desirable to provide red compositions from quince without the disadvantages described above. Any reference to prior art documents in this specification is not to be considered an admission that such prior art is widely known or forms part of the common general knowledge in the field.

The object of the present invention is to improve the state of the art and in particular to provide a red composition comprising quince juice, overcoming at least some of the disadvantages described above, or to at least provide a useful alternative. The inventors were surprised to see that the object of the present invention could be achieved by the subject matter of the independent claims. The dependent claims further develop the idea of the present invention. Accordingly, the present invention provides a red composition comprising quince juice wherein the quince juice imparts the red colour to the composition and wherein no sugar or acid is added. As used in this specification, the words “comprises”, “comprising”, and similar words, are not to be interpreted in an exclusive or exhaustive sense. In other words, they are intended to mean “including, but not limited to”.

The inventors were surprised to find that when quince juice is heated it turns red, even without the addition of sugar or acid. Under the mildly acidic conditions found in many foodstuffs, the red colour in the heated quince juice was found to be more stable when exposed to light than either a red colour from black carrot extract or carmine.

The invention also relates to the use of a red composition comprising quince juice to colour a food product, a nutritional formulation, a food supplement, a beverage, an ink or a pharmaceutical product. The inventors were surprised to find that the red composition comprising quince juice imparted attractive stable red colours when used to colour products such as yoghurt and did not adversely affect the taste.

In a further aspect, the invention relates to a method for preparing a red composition which comprises extracting juice from quince fruits and heating the juice at a temperature of between 70 and 130° C. for a period between 30 minutes and 6 hours.

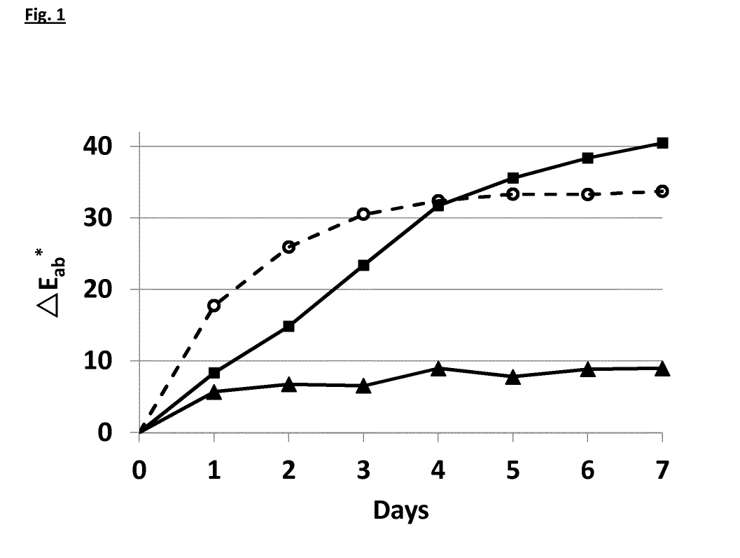

FIG. 1 shows the colour change ΔEab* of the red composition comprising quince juice of example 3 (indicated by triangles ▴), black carrot colour (indicated by squares ▪) and carmine (indicated by circles ◯) exposed to accelerated light conditions for 7 days.

Consequently the present invention relates in part to a red composition comprising quince juice wherein the quince juice imparts the red colour to the composition and wherein no sugars or acids are added.

Red is any of a number of similar colors evoked by light, consisting predominantly of the longest wavelengths of light discernible by the human eye in the wavelength range of approximately 630-700 nm. One method of measuring colour proposed by the Commission Internationale de l'Éclairage (CIE) is the CIE 1976 L*a*b* colour scale, herein abbreviated as CIELAB (CIE Technical Report, Colorimetry 2^{nd} Edition, CIE 15.2-1986, corrected reprint 1996). The CIELAB colour space is produced by plotting the quantities L*, a*, b* in rectangular coordinates. The L* coordinate of an object is the lightness intensity as measured on a scale from 0 (black) to 100 (absolute white). The a* and b* coordinates have no specific numerical limits. The parameter a* runs from pure green (negative a*) to pure red (positive a*), while b* runs from pure blue (negative b*) to pure yellow (positive b*).

The hue angle h_{ab} is calculated from a* and b* values as:

h_{ab}=arctan(b*/a*)

where h_{ab} lies between 0° and 90° if b* and a* are both positive, between 90° and 180° if b* is positive and a* is negative, between 180° and 270° if b* and a* are both negative, and between 270° and 360° if b* is negative and a* is positive.

“Red” within the scope of the present invention refers to a CIELAB hue angle h_{ab} between 335° and 80°. An angle between 335° and 80° refers to all the angles between 335° and 360° and all the angles between 0° and 80°, (0° and 360° being equivalent). Red materials with a high lightness intensity may be described as pink. The red composition of the present invention may have a CIELAB hue angle between 350° and 75°. Many red anthocyanin colours have a purple-red hue, with hue angles between 335° and 360°. It is helpful to have a range of different colours available when colouring a product, and so it is an advantage that the red composition of the present invention may be used to provide a more orange-red hue. For example, the red composition of the present invention may have a CIELAB hue angle between 10° and 70°.

Quinces are related to apples and pears, having a hard, strongly perfumed pome fruit. True quinces are Cydonia oblonga, but four other species have very similar properties; Chinese quince, Pseudocydonia sinensis; and three flowering quinces of eastern asia, Chaenomeles cathayensis, Chaenomeles japonica, and Chaenomeles speciosa. In the scope of the present invention, the term quince refers to all five of these types of quince. Accordingly, the quince in the red composition of the present invention may be selected from the group consisting of Cydonia oblonga, Pseudocydonia sinensis, Chaenomeles cathayensis, Chaenomeles japonica, Chaenomeles speciosa or mixtures of these. The quince in the red composition of the present invention may be Cydonia oblonga.

Quince juice is the juice of the quince fruit. It may be extracted by any of the methods commonly used in the art, for example a centrifugal juice extractor, a steam juicer, a masticating juicer, a triturating juicer or a fruit press. The term extraction when used in fruit processing refers to obtaining juice from the fruit, separating the juice from the other components of the fruit such as skin and pulp. The red composition of the present invention may have no sugars or acids added. That is to say, the only acids and sugars present are those originating from the quince juice.

Typically, natural quince juice contains between 5 and 14 g sugars/100 g juice. The exact amount of sugars will vary with the variety and ripeness of the quince. Accordingly, the quince juice of the current invention with no sugars added and before any evaporation contains a maximum of 14 g sugars/100 g. In the scope of the current invention, the term “sugars” refers not just to sucrose, but also to naturally occurring monosaccharides, naturally occurring disaccharides and to honey. In many food and beverage applications, added sugar is not desirable due to a wish to limit calorie intake or to avoid potential tooth decay, especially in food or beverages for young children. Added acids may present other problems. Ingredients with a low pH can adversely affect the taste of many foods and furthermore, some food matrices are not stable in the presence of low pH ingredients. The term acids includes acids from natural sources such as lemon juice which contains citric acid. Natural quince juice has a pH between 2.4 and 3.6 depending on variety and degree of ripeness of the quince. The addition of other non-acid components may lead to an increase in pH. Accordingly, the red composition according to the invention may have a pH greater than 2.4, for example between 2.4 and 5.5, for further example between 2.4 and 3.6. As measurements of pH are temperature dependent, values given in the present specification refer to the pH at 25° C. For compositions where the quince juice has been evaporated to concentrate it, or where the composition is a dry powder, the pH is measured after adjusting the composition to 5° Brix by the addition of water. The inventors were surprised to find that—contrary to what could have been expected from the prior art—when quince juice is heated it turns red, even without the addition of sugar or acid. Accordingly the red composition of the present invention may consist of quince juice.

It is often convenient when handling coloured compositions for them to be provided in the form of a powder. When coloured compositions are to be added to other ingredients, for example to provide colour, it is often inefficient to transport and store the coloured composition in a liquid form, where much of the weight and volume is simply water. It may be preferable to transport the coloured composition as a dry powder which is then reconstituted with water to form a liquid composition. It is therefore an advantage that the red composition of the present invention may be a powder which is freely soluble in water. The inventors found that quince flesh which has been heated with acid and sugar to make it turn red may be freeze-dried and ground to form a powder. However, the quince flesh contains a number of insoluble components and so this powder is not freely soluble in water. This limits its use, particularly for colouring beverages where it is often desirable to have a transparent beverage with no sediment. It is therefore an advantage that the red composition comprising quince juice of the current invention may be dried to a powder which is freely soluble in water, for example by freeze drying or spray drying. In the scope of this invention, freely soluble in water means that 50 g of a material can be completely dissolved in 100 ml deionised water at 20° C.

For certain applications it is an advantage that the red composition comprising quince juice can be directly spray dried or freeze dried, minimizing the number of ingredients. However, a powdered form of the red composition may also be obtained by mixing with a soluble powder carrier before drying. The red composition of the invention may be a powder further comprising a powder carrier. Combining the red composition with a powder carrier can be useful to ensure a rapid dispersal into solution without clumping on the solution surface, or to give desired powder flow properties. Also, when very small quantities of the red composition are required it can be difficult to weight them accurately, especially in a production environment. By combining the red composition with a powder carrier, the total amount to be weighed increases and accurate dosing becomes easier. The powder carrier in the present invention may be a modified starch such as maltodextrin. For example maltodextrin may be dissolved in the heated quince juice and the mixture spray-dried to produce a powder.

As colouring materials from natural sources are often sensitive to changes in pH it is valuable to be able to provide a red composition which retains its colour despite changes in pH.

In the CIELAB colour space, colour difference may be calculated as a single value taking into account the differences between the L*, a* and b* values of two samples. The colour difference ΔE_{ab}* is calculated as follows:

ΔEab*=\sqrt{(ΔL*)²+(Δa*)²+(Δb*)²}

Surprisingly, the red composition of the present invention shows good stability with regard to pH. For example, the colour difference ΔE_{ab}* between pH 3 and pH 5 is less than 10.

A red composition comprising quince juice may be used to colour a wide variety of materials. These materials may be food products, nutritional formulations, food supplements, beverages, inks or pharmaceutical products. It is an advantage to be able to colour materials red using an ingredient from a natural source, especially a red colour which has good stability to light. It is a further advantage to be able to colour materials red using a material from a natural source without added sugar or acid. The red composition according to the invention may be used to colour a food product, a nutritional formulation, a food supplement, a beverage, an ink or a pharmaceutical product.

A food product which may be coloured according to the invention may be a dairy product, for example yoghurt; an ice-cream; a confectionery product; a bakery product; a pet food; a fruit or vegetable preparation, for example fruit or vegetable purees for infants. It is particularly advantageous to be able to provide a red composition for use in fruit purees for infants which comprises quince juice and where no sugar or acid has been added. Infants do not appreciate overly sour fruit purees and their parents would prefer not to see ingredients other than fruit on the ingredient list. The beverages which may be coloured according to the invention may be chilled or shelf stable beverages; carbonated drinks; beverages containing coloured fruit pieces or pulp; fruit juices; vegetable juices; squashes and cordials.

Inks are liquids or pastes used to colour a surface, in particular to produce an image, text, or design. Ink is generally applied with a pen, a brush or by a printing method. There are only a limited number of edible inks, and very few have colours from natural sources. The red composition of the present invention may be used in an edible ink, for example to decorate food, to mark pharmaceutical tablets or for use on packaging which will be in direct contact with food. Food with printed text, logos, images or designs can be very appealing to consumers and may provide aesthetic enhancement, product recognition, personalization and a sense of fun.

A range of different colours can be obtained by mixing the red composition of the invention with other coloured compositions. For example, mixing the red composition with a blue coloured composition results in a purple colour. The red composition of the invention may be used in combination with at least one other coloured composition.

Another aspect of the invention relates to a method of preparing a red composition comprising extracting juice from quince fruits and heating the juice at a temperature of between 70 and 130° C. for a period between 30 minutes and 6 hours. A pressure cooker or similar device may be used to reach temperatures in excess of 100° C.

The juice may be filtered before being heated. In particular the juice may be filtered when the process used to extract the juice has not fully separated it from the other components of the fruit, such as skin and pulp. Where particles of quince flesh and/or skin remain in the juice, the development of red colour in the juice during heating may be inhibited. The mixture may appear red after heating, but after filtering out the particles, the remaining juice is found not to be red, for example it may be colourless or a pale straw colour.

The juice may have a pH between 2.8 and 5.5 during heating, for example between 3 and 4. These pH values typically occur without the need to add acids and so it is advantageous that the red composition can be generated under these conditions, avoiding the need for additional ingredients to control the pH during processing or to correct the pH after processing, for example to make the red composition palatable. The method may further comprise drying the heated juice to form a powder. The drying method is not particularly limited and can be selected from those methods well known for drying liquids. Spray-drying provides a convenient method of forming a powder from the heated juice. The heated juice can be spray-dried alone, or with the addition of a powder carrier such as maltodextrin.

Those skilled in the art will understand that they can freely combine all features of the present invention disclosed herein. In particular, features described for the product of the present invention may be combined with the method of the present invention and vice versa. Further, features described for different embodiments of the present invention may be combined.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification. Further advantages and features of the present invention are apparent from the figures and non-limiting examples.

### EXAMPLE 1

### Treatment of Quince with Acid and Heat

Quince fruits (Cydonia oblonga) were cut into pieces and freeze-dried. The freeze-dried quince pieces were then milled into a fine powder. This quince powder (2%, w/v) was dispersed in a citric acid solution (10% of citric acid (w/v) in deionised water) and then heated at 95° C. for 3 hours. The resulting liquid had a pH of 1.8 and appeared red in colour. The red liquid contained suspended solids. After filtering a portion of the red liquid, the filtrate was found to be much paler in colour, with much of the red colour remaining in the filter. A further portion of the red liquid was freeze-dried to form a powder. The powder did not completely go into solution when mixed into water. The high acidity of this composition and the partially insoluble nature of the red material within the composition limits its usefulness.

### EXAMPLE 2

### Treatment of Quince with Heat

Quince fruits (Cydonia Oblonga) were cut into pieces and freeze-dried. The freeze-dried quince pieces were then milled into a fine powder. This quince powder was dispersed in deionised water (2% w/v) and heated for 4 hours at 95° C. The resulting solution had a pH of 3.5 and appeared orange-brown in colour. The solution contained suspended solids. After filtering a portion of the solution, the filtrate was found to be colorless. The experiment showed that heating quince flesh in the absence of added acid did not produce a red composition.

### EXAMPLE 3

### Treatment of Quince Juice with Heat

A juice maker (Rotor Vitamat Powerjucer) was used to extract juice from quince fruit (Cydonia oblonga). The pale yellow juice was filtered and then heated at 95° C. for 3 hours. The resulting juice was red in colour, had a pH of 3.2 and contained no suspended solids. A portion of the juice was freeze dried with 20% w/v of maltodextrin (21DE) in order to obtain a pink, freely soluble powder. This shows that surprisingly, by heating quince juice it is possible to obtain a red composition without adding sugars or acids.

### EXAMPLE 4

### Stability Tests

### Heat Stability

To assess the stability of the red composition comprising quince juice against heat, a vial containing 30 ml of red quince juice from example 3 was heat treated at 75° C. for 35 minutes. The CIELAB values were measured before and after heat treatment. The colour measurement was performed using a ColorEye CE 7000 A from Gretagmacbeth, X-rite Europe AG (provided with the IQC V7.0 software) with a 10° angle and a D65 light source.

CIELAB values before and after heat treatment

| | L* | a* | b* | h_{ab} | ΔE_{ab}* |
|---|---|---|---|---|---|
| Before | 15.94 | 32.05 | 24.03 | 36.9 | — |
| After | 20.41 | 29.30 | 29.33 | 45.0 | 7.45 |

The results show that the red composition comprising quince juice has good stability under the heat conditions likely to be encountered in pasteurization processes.

### pH Stability

The following buffer solutions were prepared:
pH2 Acetate 0.1M
pH3 Acetate 0.1M
pH4 Acetate 0.1M
pH5 Acetate 0.1M

10% of freeze-dried powder (w/v) from example 3 was dissolved in each solution, the results of the Lab* measurements are below. The colour difference ΔE_{ab}* was calculated for each sample compared to the sample at pH3.

CIELAB values at different pH.

| | L* | a* | b* | h_{ab} | ΔE_{ab}* |
|---|---|---|---|---|---|
| pH2 | 31.65 | 17.94 | 38.59 | 65.1 | 1.41 |
| pH3 | 31.05 | 16.80 | 38.01 | 66.2 | — |
| pH4 | 30.85 | 15.94 | 37.59 | 67.0 | 0.98 |
| pH5 | 28.29 | 22.89 | 39.52 | 59.9 | 6.85 |

The results show that the red composition comprising quince juice has good colour stability under acidic conditions.

### Light Stability

Different red colours from natural sources were compared for light stability. The samples were the red quince juice from example 3; a solution of carmine (0.023% Carmine P45, D D Williamson) in a pH3 buffer; and a solution of black carrot colour (0.13% ColorFruit® carrot 9WS, Chr. Hansen) in a pH3 buffer. 30 ml vials of these samples were placed under accelerated light conditions for 7 days. The accelerated lighting conditions were generated using an ATLAS Suntest® XLS(II) equipped with a Xenon Arc lamp set up to an energy of irradiation of 30±0.2 W/m² based on the 300-400 nm irradiance range (or 8420±10 Lux as also determined experimentally), UV filters and cooling system. The accelerated test was carried out at 25° C.; the Lab* values for each sample were measured prior to the test (t₀) and every day during the test. The ΔE_{ab}* values for each day compared to (t₀) are plotted in FIG. 1.

The results show that the red composition comprising quince juice is more stable to light under these conditions than the natural red colours from either black carrot or carmine.

### EXAMPLE 5

### Use of the Red Composition to Colour Yoghurt

Freeze-dried powder from example 3 was mixed with Nestlé® LC1® plain yoghurt at a level of 12% (w/w). The yoghurt was gently mixed until the colour was homogenous. LC1® strawberry yoghurt was used as a comparison, having been sieved to remove solid pieces (strawberries). LC1® strawberry yoghurt is coloured partly by the juice of the strawberries it contains and partly by the use of beetroot red. The two yoghurt samples were stored at 8° C. for 4 weeks. Initial Lab* values were measured and then measurement taken every week during the storage in order to assess colour change. Both samples showed good stability. The ΔE_{ab}* for LC1® strawberry yoghurt was 1.99 after 4 weeks, and the yoghurt with 12% freeze-dried powder from example 3 was slightly more stable, with a ΔE_{ab}* of 0.85 after 4 weeks. The freeze-dried powder from example 3 did not significantly affect the yoghurt pH. The initial pH was 4.14 with a pH of 4.10 after 4 weeks. In contrast, when the freeze-dried powder from example 1 was added to yoghurt, the pH dropped from pH 4 to pH 2 and the yoghurt developed an unpleasant sour taste.

The results show that the red composition comprising quince juice is suitable for colouring yoghurt, providing a stable colour without adversely affecting the taste.

1. Red composition comprising quince juice wherein the quince juice imparts the red color to the composition and no sugars or acids are added.

2. A red composition according to claim 1 wherein the red composition has a pH greater than 2.4.

3. A red composition according to claim 1, wherein the red composition consists essentially of quince juice.

4. A red composition according to claim 1, wherein the red composition is in the form of a powder which is freely soluble in water.

5. A red composition according to claim 1, wherein the red composition is a powder comprising a powder carrier.

6. A red composition according to claim 5 wherein the powder carrier is a modified starch.

7. A red composition according to claim 1, wherein the quince is selected from the group consisting of Cydonia oblonga, Pseudocydonia sinensis, Chaenomeles cathayensis, Chaenomeles japonica, Chaenomeles speciosa and mixtures thereof.

8. A red composition according to claim 1, wherein the ΔE_{ab}* between pH 3 and pH 5 is less than 10.

9. A method of coloring a product selected from the group consisting of a food product, a nutritional formulation, a food supplement, a beverage, an ink and a pharmaceutical product comprising adding quince juice thereto.

10. A method of coloring a product selected from the group consisting of a food product, a nutritional formulation, a food supplement, a beverage, an ink and a pharmaceutical product comprising adding quince juice wherein the quince juice imparts the red color to the composition and no sugars or acids are added thereto.

11. Method according to claim 9, wherein the food product is selected from the group consisting of a dairy product; a fruit or vegetable preparation; an ice-cream; a confectionery product; a bakery product; and a pet food.

12. Method according to claim 9, wherein the composition is combined with at least one other colored composition.

13. Method of preparation of a red composition comprising extracting juice from quince fruits and heating the juice at a temperature of between 70 and 130° C. for a period between 30 minutes and 6 hours.

14. A method according to claim 13 wherein the juice has a pH between 2.8 and 5.5 during heating.

15. A method according to claim 13 further comprising drying the heated juice to form a powder.

16. Method according to claim 10, wherein the food product is selected from the group consisting of a dairy product; a fruit or vegetable preparation; an ice-cream; a confectionery product; a bakery product; and a pet food.

17. Method according to claim 10, wherein the composition is combined with at least one other colored composition.
